(19) United States
(12) Patent Application Publication
(10) Pub. No.: US 2012/0295127 A1
(43) Pub. Date: Nov. 22, 2012

(54) SCULPTED ALUMINUM FASCIA VALANCE SYSTEM AND METHOD OF MAKING SAME

(75) Inventor: Tyrone John Anthony Pereira, San Diego, CA (US)

(73) Assignee: NUTMEG INDUSTRIES, INC., Lake Elsinore, CA (US)

(21) Appl. No.: 13/111,216

(22) Filed: May 19, 2011

(51) Int. Cl. B32B 3/30; B24C 1/00

(52) U.S. Cl. 428/600; 451/40

(57) ABSTRACT

A sculpted aluminum fascia valance system and method of making it according to certain embodiments of the invention may include an aluminum fascia valance that has been sculpted by a water jet cutter. The sculpted design may be an ornamental design, or it may be a company name, logo, or tagline. Lights or colored sheets of plastic or fabric may be used behind the sculpted aluminum fascia to enhance the aesthetic appeal of the sculpted design.

### FIELD OF THE INVENTION

The present invention relates in general to a novel sculpted aluminum fascia valance system and method of making the same.

### BACKGROUND ART

This section describes the background of the disclosed embodiment of the present invention. There is no intention, either express or implied, that the background art discussed in this section legally constitutes prior art.

Fascia valances are commonly used to conceal unattractive hardware, which is used for the mounting of various window coverings, such as shades, curtains, and blinds. Aluminum fascia valances are available in lightweight systems that are designed to interlock the fascia valance with mounting brackets, allowing for a secure, fast and easy installation. Aluminum fascia valances are often used due to this practical design. However, aluminum fascia valances are rather plain, adding little aesthetic appeal.

Attractive sculpted wooden fascia valances are available. However, these are too heavy in weight to be used in some settings, and they are not available in an easy to install interlocking system.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a pictorial view of the sculpted aluminum fascia valance system, wherein the sculpted aluminum fascia valance system is shown in use in connection with a window covering;

FIG. 2 is a frontal view of a sculpted aluminum fascia valance, which is constructed according to an embodiment of the present invention, with a company name, logo, and tagline sculpted into the aluminum fascia valance; and

FIG. 3 is a cross-sectional view of an aluminum fascia valance that is being sculpted by a water jet cutter.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

A sculpted aluminum fascia valance system according to certain embodiments of the invention may include at least one sculpted aluminum fascia valance. The aluminum fascia valance may be sculpted with an ornamental design. In some embodiments the aluminum fascia valance may be sculpted with a company name, logo, and/or tagline, so that the sculpted aluminum fascia valance can serve the additional purpose of advertisement for a business.

In one embodiment, a colored piece of plastic or fabric may be placed behind the sculpted aluminum valance system to add an additional source of color viewable through the openings of the sculpted design in the sculpted aluminum valance. In other embodiments, LED or neon lighting may be used behind the sculpted aluminum valance system to enhance the visual appeal of the sculpted design by allowing light to shine through the sculpted design.

A method of making a sculpted aluminum fascia valance system according to certain embodiments of the invention, comprising using a water jet cutter to sculpt a design into the aluminum fascia valance, which uses a stream of high velocity high pressure water to cut intricate designs into the aluminum fascia valance. A commercially available water jet cutter may be used, such as a Flow® water jet cutter from Flow International Corporation, 23500 64^{th} Avenue South, Kent, Wash. 98032. This method may be used to sculpt any aluminum fascia valance, such as the Skyline™ aluminum fascia valance that is commercially available from RollEase, Inc., 200 Harvard Avenue, Stamford, Conn. 06902. The aluminum fascia valance to be sculpted may be of any color.

The sculpting by the water jet cutter is guided by a computer and software system that allows for the creation of intricate and detailed designs to be sculpted into the aluminum fascia valance.

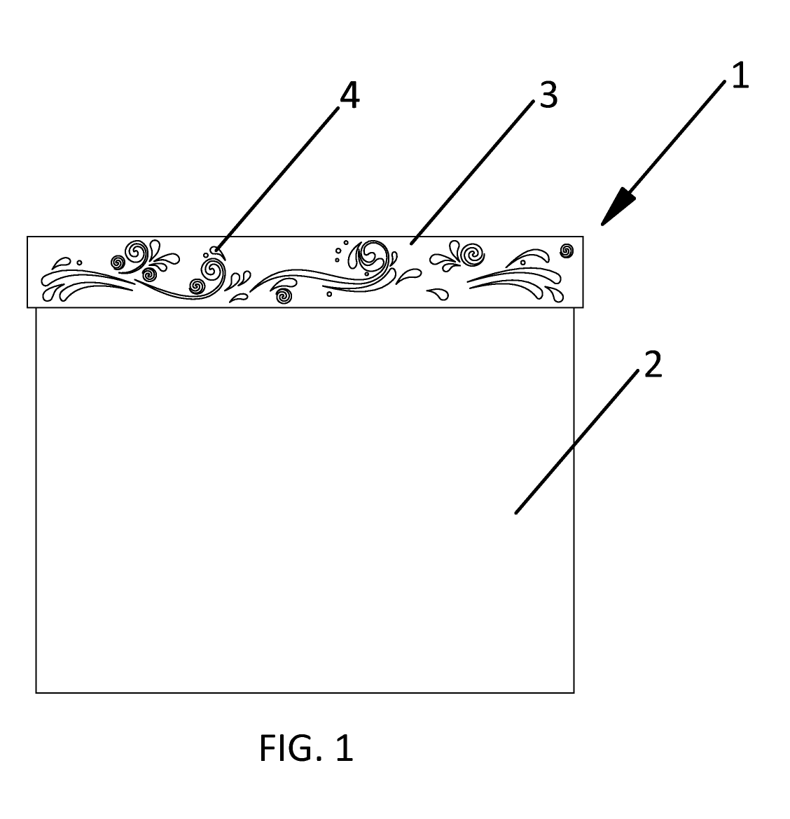

Referring now to the figures, FIG. 1 shows the sculpted aluminum fascia valance system 1, wherein the sculpted aluminum fascia valance system 1 is shown in use in connection with a window covering 2. The sculpted aluminum fascia valance system 1 contains a sculpted aluminum fascia valance 3 that has been sculpted with a decorative design 4.

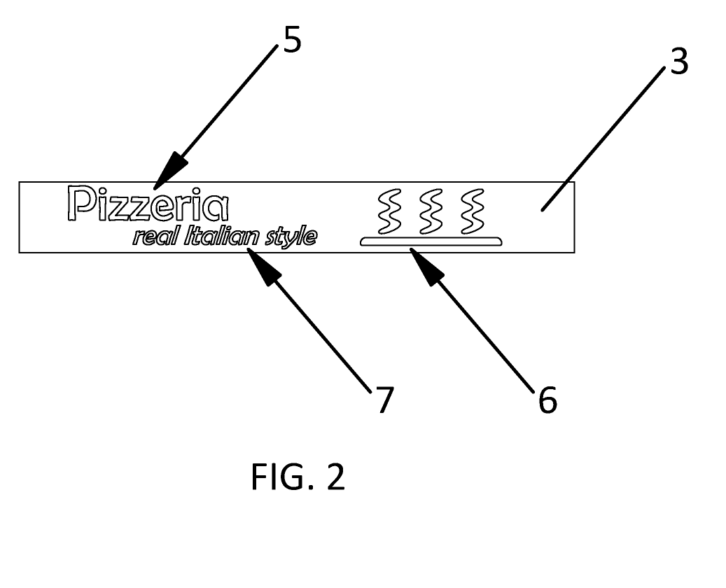

FIG. 2 depicts a sculpted aluminum fascia valance 3, wherein the decorative design sculpted into the aluminum fascia valance is comprised of a company name 5, company logo 6, and company tagline 7.

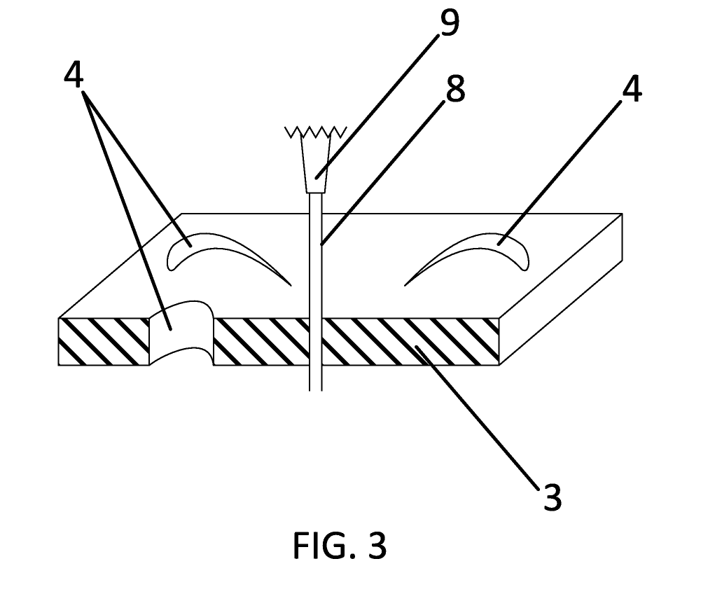

FIG. 3 depicts a cross sectional view of an aluminum fascia valance 3 that is being sculpted by a stream of water 8 from a water jet cutter 9 (only partially shown) to create a decorative design 4 on aluminum fascia valance 3.

While particular embodiments of the present invention have been disclosed, it is to be understood that various different modifications are possible and are contemplated within the true spirit and scope of the appended claims. There is no intention, therefore, of limitations to the exact abstract or disclosure herein presented.

What is claimed is:

1. A sculpted aluminum fascia valance system, comprising an aluminum fascia valance having a design sculpted into the valance.

2. A sculpted aluminum fascia valance system according to claim 1, wherein the design was sculpted into the valance using a water jet cutter.

3. A sculpted aluminum fascia valance system according to claim 1, wherein the design is an ornamental design.

4. A sculpted aluminum fascia valance system according to claim 1, wherein the design is a company name, a company logo, or a company tagline.

5. A sculpted aluminum fascia valance system according to claim 1, further comprising a piece of colored plastic or fabric that is positioned behind the sculpted aluminum fascia valance, wherein the piece of colored plastic or fabric is viewable through the sculpted design.

6. A sculpted aluminum fascia valance system according to claim 1, further comprising a light source that is positioned behind the sculpted aluminum fascia valance, wherein the light is viewable through the sculpted design.

7. A method of making a sculpted aluminum fascia valance system, comprising cutting a design into an aluminum fascia valance with a water jet cutter.

8. The method of making a sculpted aluminum fascia valance system according to claim 7, wherein the water jet cutter is guided by a computer and software system that allows for the creation of intricate and detailed designs to be sculpted into the aluminum fascia valance.

9. The method of making a sculpted aluminum fascia valance system according to claim 7, wherein the design is an ornamental design.

10. The method of making a sculpted aluminum fascia valance system according to claim 7, wherein the design is a company name, a company logo, or a company tagline.

11. The method of making a sculpted aluminum fascia valance system according to claim 7, further comprising positioning a piece of colored plastic or fabric behind the sculpted aluminum fascia valance so that the colored plastic or fabric is viewable through the sculpted design.

12. The method of making a sculpted aluminum fascia valance system according to claim 7, further comprising positioning a light source behind the sculpted aluminum fascia valance so that the light is viewable through the sculpted design.
